(19) United States
(12) Patent Application Publication
(10) Pub. No.: US 2002/0083714 A1
(43) Pub. Date: Jul. 4, 2002

(54) Liquid fuel combustion system and method

(76) Inventor: Daniel Bakholdin, Canyon Country, CA (US)

Correspondence Address: IRELL & MANELLA LLP, Suite 900, 1800 Avenue of the Stars, Los Angeles, CA, 90067, US

(21) Appl. No.: 09/967,818

(22) Filed: Sep. 28, 2001

Related U.S. Application Data
(60) Provisional application No. 60/244,940, filed on Nov. 1, 2000.

(51) Int. Cl. F02C 7/224

(52) U.S. Cl. 60/776; 60/736

(57) ABSTRACT

In a liquid fuel turbine engine, the liquid fuel is vaporized prior to being mixed with air and injected into the combustion chamber to be combusted therein. The heat for vaporizing the fuel may be provided by the turbine engine and may be drawn from the turbine exhaust or may be electrically generated, where electrical power may be supplied by a generator coupled to the turbine.

### RELATED APPLICATIONS

This application claims the priority of provisional patent application serial No. 60/244,940 filed Nov. 1, 2000.

### BACKGROUND OF THE INVENTION

A turbogenerator electric power generation system is generally comprised of a compressor, a combustor including fuel injectors and an ignition source, a turbine, and an electrical generator. Often, the system includes a recuperator to preheat combustion air with waste heat from the turbine exhaust. The system can run on gaseous fuel or liquid fuel. Typically, liquid fuels are more cost effective and safer to transport and store. Therefore, what is needed is a turbogenerator system to efficiently and safely operate on liquid fuel.

### SUMMARY OF THE INVENTION

In one aspect, the present invention provides a turbine engine comprising a turbine driven by hot gas, a combustor for combusting fuel and compressed air to generate the hot gas, a fuel injector connected to the combustor to introduce liquid fuel into the combustor, and a source of heat external to the combustor and coupled to the injector for heating the injector to vaporize the liquid fuel flowing therethrough.

In another aspect, the present invention provides a method of operating a turbine engine having a combustor for combusting liquid fuel and compressed air to generate hot gas, the method comprising passing liquid fuel through an injector and into the combustor to be combusted therein, connecting a source of heat to the injector wherein the source of heat is external to the combustor, and heating the injector to a temperature sufficient to vaporize the liquid fuel flowing therethrough.

In a further aspect of the present invention, the source of heat may be electric power or may be turbine exhaust gas. An electric heater such as a band heater may be disposed around the injector. The electric power may be supplied by a generator rotationally coupled to the turbine engine, or by a battery, or by a utility grid.

### BRIEF DESCRIPTION OF THE DRAWINGS

FIG. 1 is perspective view, partially in section, of a turbogenerator system according to the present invention;

FIG. 2 is a plan view of a combustor housing for the turbogenerator system of FIG. 1;

FIG. 3 is a sectional view of the combustor housing of FIG. 2 taken along line 3--3 of FIG. 2;

FIG. 4 is a sectional view of the combustor housing of FIG. 3 taken along line 4--4 of FIG. 3;

FIG. 5 is an enlarged sectional view, partially schematic, of an alternate combustor housing for the turbogenerator system of FIG. 1;

FIG. 6 is an enlarged sectional view of a fuel injector for the turbogenerator system of FIG. 1;

FIG. 7 is an enlarged sectional view of a fuel injector according to the invention for use with the turbogenerator system of FIG. 1;

FIG. 8 is an enlarged sectional view of another fuel injector according to the invention for use with the turbogenerator system of FIG. 1; and

FIG. 9 is a functional diagram showing the turbogenerator of FIG. 1 and an associated power controller.

### DETAILED DESCRIPTION OF THE INVENTION

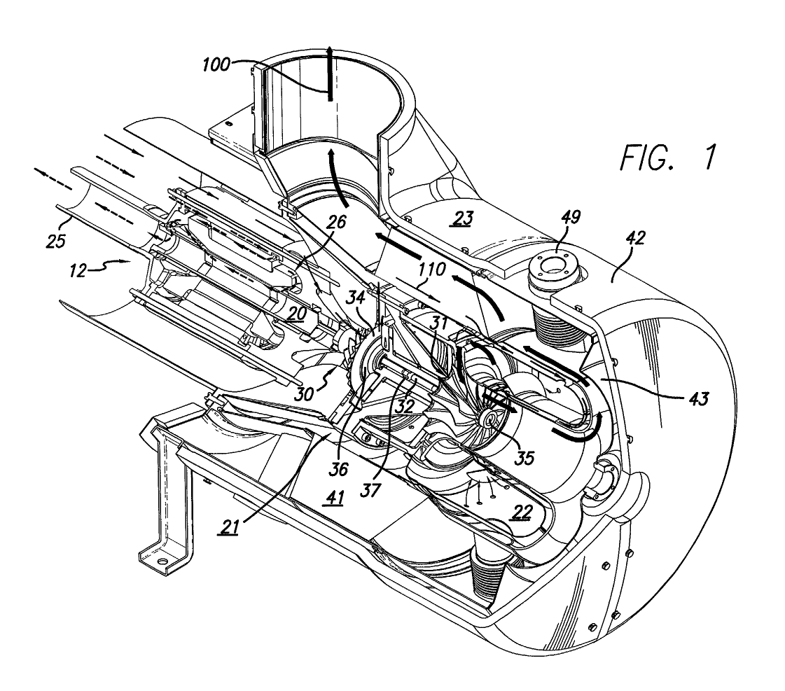

Referring to FIG. 1, integrated turbogenerator system 12 generally includes generator 20, power head 21, combustor 22, and recuperator (or heat exchanger) 23. Power head 21 of turbogenerator 12 includes compressor 30, turbine 31, and bearing rotor 32. Tie rod 33 to magnetic rotor 26 (which may be a permanent magnet) of generator 20 passes through bearing rotor 32. Compressor 30 includes compressor impeller or wheel 34 that draws air flowing from an annular air flow passage in outer cylindrical sleeve 29 around stator 27 of the generator 20. Turbine 31 includes turbine wheel 35 that receives hot exhaust gas flowing from combustor 22. Combustor 22 receives preheated air from recuperator 23 and fuel through a plurality of fuel injectors disposed through fuel injector guides 49. Compressor wheel 34 and turbine wheel 35 are supported on bearing shaft or rotor 32 having radially extending air-flow bearing rotor thrust disk 36. Bearing rotor 32 is rotatably supported by a single air-flow journal bearing within center bearing housing 37 while bearing rotor thrust disk 36 at the compressor end of bearing rotor 32 is rotatably supported by a bilateral air-flow thrust bearing.

Generator 20 includes magnetic rotor or sleeve 26 rotatably supported within generator stator 27 by a pair of spaced journal bearings. Both rotor 26 and stator 27 may include permanent magnets. Air is drawn by the rotation of rotor 26 and it travels between rotor 26 and stator 27 and further through an annular space formed radially outward of the stator to cool generator 20. Inner sleeve 25 serves to separate the air expelled by rotor 26 from the air being drawn in by compressor 30, thereby preventing preheated air from being drawn in by the compressor and adversely affecting the performance of the compressor (due to the lower density of preheated air as opposed to ambient-temperature air).

In operation, air is drawn through sleeve 29 by compressor 30, compressed, and directed to flow into recuperator 23. Recuperator 23 includes annular housing 40 with heat transfer section or core 41, exhaust gas dome 42, and combustor dome 43. Exhaust heat from turbine 31 is used to preheat the compressed air flowing through the recuperator before it enters combustor 22, where the preheated air is mixed with fuel and ignited in the combustor, such as by electrical spark, hot surface ignition, or catalyst. The fuel may also be premixed with all or a portion of the preheated air prior to injection into the combustor. The resulting combustion gas expands in turbine 31 to drive turbine impeller 35 and, through common shaft 32, drive compressor 30 and rotor 26 of generator 20. The expanded turbine exhaust gas then exits turbine 31 and flows through recuperator 23 before being discharged from turbogenerator 12.

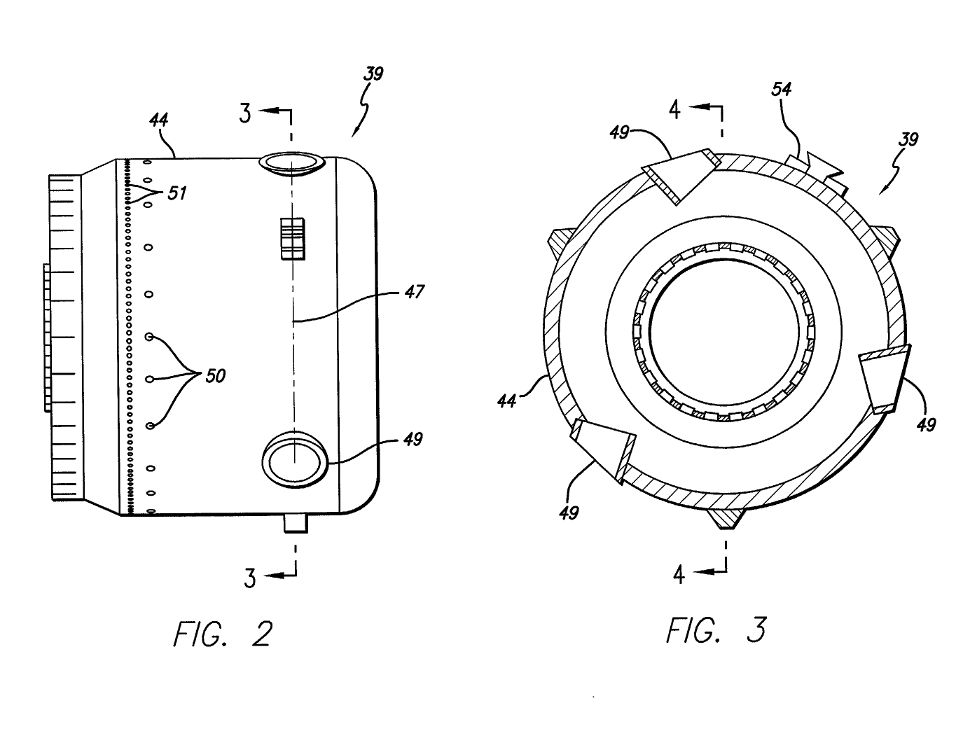

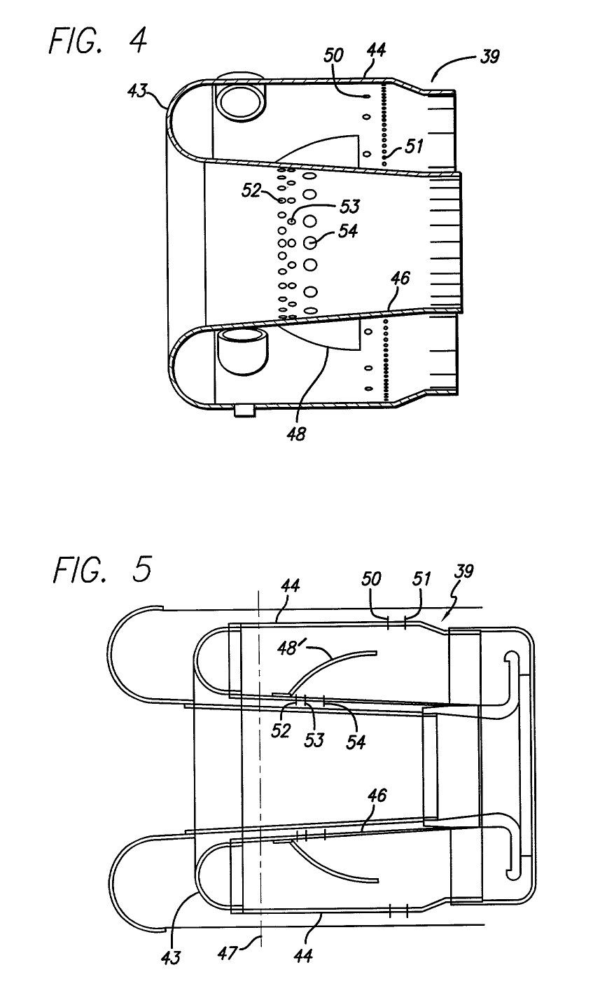

Combustor housing 39 of combustor 22 is illustrated in FIGS. 2 through 4, and generally comprises cylindrical outer liner 44 and tapered inner liner 46 that, together with combustor dome 43, form generally expanding annular combustion housing or chamber 39 from combustor dome 43 to turbine 31. Plurality of fuel injector guides 49 may position the fuel injectors 14 to tangentially introduce a fuel/air mixture at the combustor dome 43 end of the annular combustion housing 39 along the fuel injector axis or centerline 47. Centerline 47 includes an igniter cap to position an igniter (not shown) within the combustor housing 39. Combustion dome 43 is rounded out to permit the swirl pattern from fuel injectors 14 to fully develop and to reduce structural stress loads in the combustor.

Flow control baffle 48 extends from tapered inner liner 46 into annular combustion housing 39. Baffle 48 is typically skirt-shaped and may extend between one-third and one-half of the distance between tapered inner liner 46 and cylindrical outer liner 44. Three rows of spaced offset air dilution holes 52, 53, and 54 are formed in tapered inner liner 46 underneath flow control baffle 48 to introduce dilution air into annular combustion housing 39. The first two (2) rows of air dilution holes 52 and 53 (closest to fuel injector centerline 47) may be the same size as one another but both are typically smaller than the third row of air dilution holes 54.

In addition, two (2) rows of a plurality of spaced air dilution holes 50 and 51 are formed in cylindrical outer liner 44 to introduce more dilution air downstream from flow control baffle 48. The plurality of holes 50 closest to flow control baffle 48 may be larger and less numerous than the second row of holes 51.

Alternate combustor housing 39′ is illustrated in FIG. 5 and is substantially similar to combustor housing 39 of FIGS. 2-4. However, flow control baffle 48′ extends between one-half to two-thirds of the distance between tapered inner liner 46 and cylindrical outer liner 44.

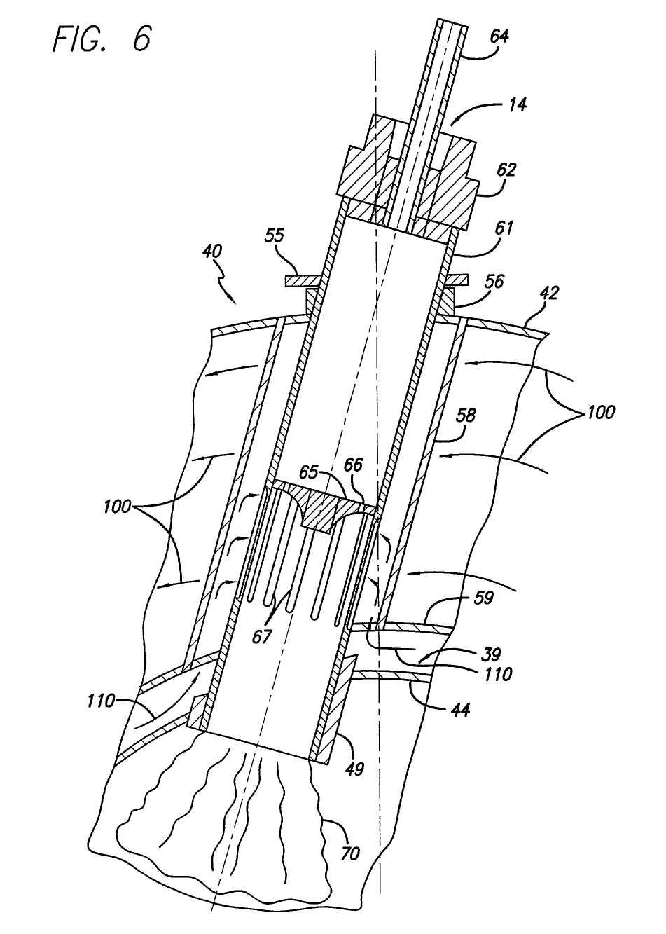

FIG. 6 illustrates fuel injector 14 extending through recuperator housing 40 and into combustor housing 39 through fuel injector guide 49. Fuel injector flange 55 is attached to boss 56 on exhaust gas dome 42 and extends through angled tube 58 between exhaust gas dome 42 and inner recuperator wall 59. Angled tube extends from exhaust gas dome 42 to inner recuperator wall 59 and is exposed to turbine exhaust 100 flowing through exhaust dome 42 towards core 41 of recuperator 23. Fuel injector 14 extends through fuel injector guide 49 in cylindrical outer liner 44 of combustor housing 39 and into the interior of annular combustion housing 39.

Fuel injector 14 generally comprises injector tube 61 having an inlet end and a discharge end. The inlet end of injector tube 61 includes coupler 62 having fuel inlet tube 64 that provides fuel to injector tube 61. The fuel may be distributed within injector tube 61 through optional centering ring 65 having plurality of spaced openings 66 to permit the passage of fuel. Openings 66 serve to provide a good distribution of the fuel within injector tube 61.

The space between angled tube 58 and outer injector tube 61 is open to the space between inner recuperator wall 59 and cylindrical outer liner 44 of combustor housing 39. Heated compressed air 110 from recuperator 23 is supplied to the space between inner recuperator wall 59 and cylindrical outer liner 44 of combustor housing 39, from where it flows to the interior of angled tube 58. Plurality of elongated slits 67 in injector tube 61 downstream of centering ring 65 provide compressed air 110 from angled tube 58 to the fuel flowing in injector tube 61 downstream of centering ring 65. The downstream face of the centering ring 65 can be sloped to help direct compressed air 110 entering injector tube 61 in a downstream direction.

A more detailed description of a preferred combustor and fuel injector system can be found in U.S. Pat. No. 5,850,732, issued Dec. 22, 1998 to Jeffrey W. Willis et al, entitled “Low Emissions Combustion System”, assigned to the same assignee as this application, and hereby incorporated in its entirety by reference thereto.

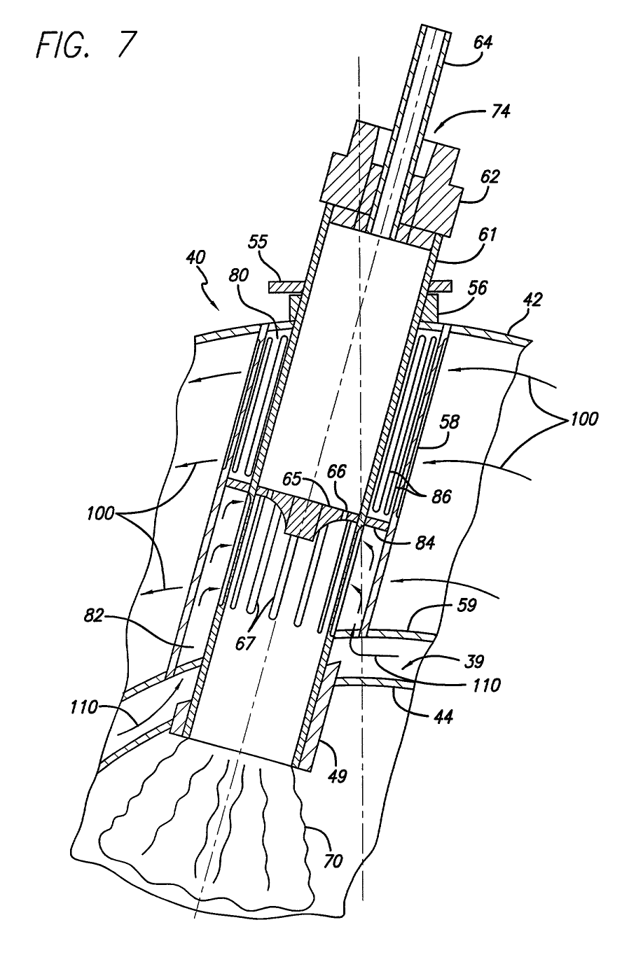

Referring to FIG. 7, angled tube 58 of alternative fuel injector 74 is formed with upper chamber 80 and lower chamber 82 divided by annular wall 84. Lower chamber 82 receives heated compressed air 110 flowing from recuperator 23 and passes it into injector tube 61 through elongated slits 67. Upper chamber 80 is formed with elongated slits 86 extending around the circumference of angled tube 58 from annular wall 84 to exhaust dome 42.

In operation, turbine exhaust 100 flowing through exhaust dome 42 enters elongated slits 86 and heats injector tube 61 and thereby also heats the liquid fuel flowing through the injector tube. The liquid fuel is thus heated beyond its flash point and is vaporized prior to reaching elongated slits 67, where it mixes with heated compressed air 110 to form a combustible vapor mass that is then combusted within combustor housing 39 to form flame 70. Alternatively, because the fuel/air mixture is vaporized, combustor housing 39 may contain catalysts and thus support catalytic combustion of the combustible vapor mass. Although turbine exhaust 110 will transfer some of its heat to the fuel and thus transfer less heat to compressed air 100, the benefits of vaporizing the fuel are believed to outweigh the reduction in temperature of heated compressed air 110 entering combustor housing 39.

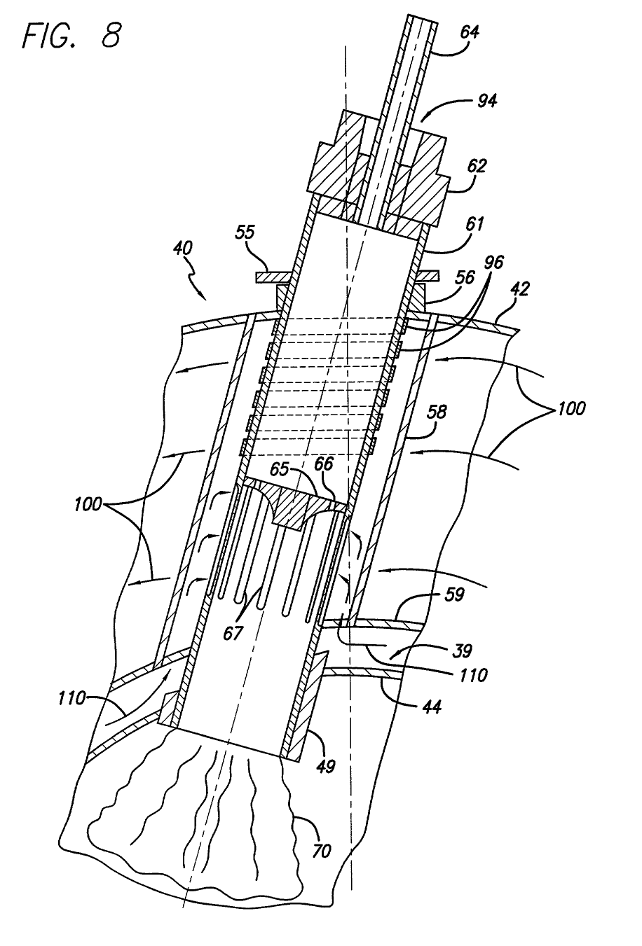

Referring to FIG. 8, alternative fuel injector 94 includes electric band heater 96 wrapped around the upper portion of injector tube 61. Heater 96 includes an electric resistive element that is supplied with electric power to generate heat and thus heat the fuel flowing through injector tube 61. As described above, the fuel is thereby vaporized prior to mixing with heated compressed air 110 in the lower portion of injector tube 61. In yet another embodiment, injector 74 may also include electric heater 96 for use during startup of turbogenerator 12 while turbine exhaust 100 is not yet hot enough to vaporize the fuel.

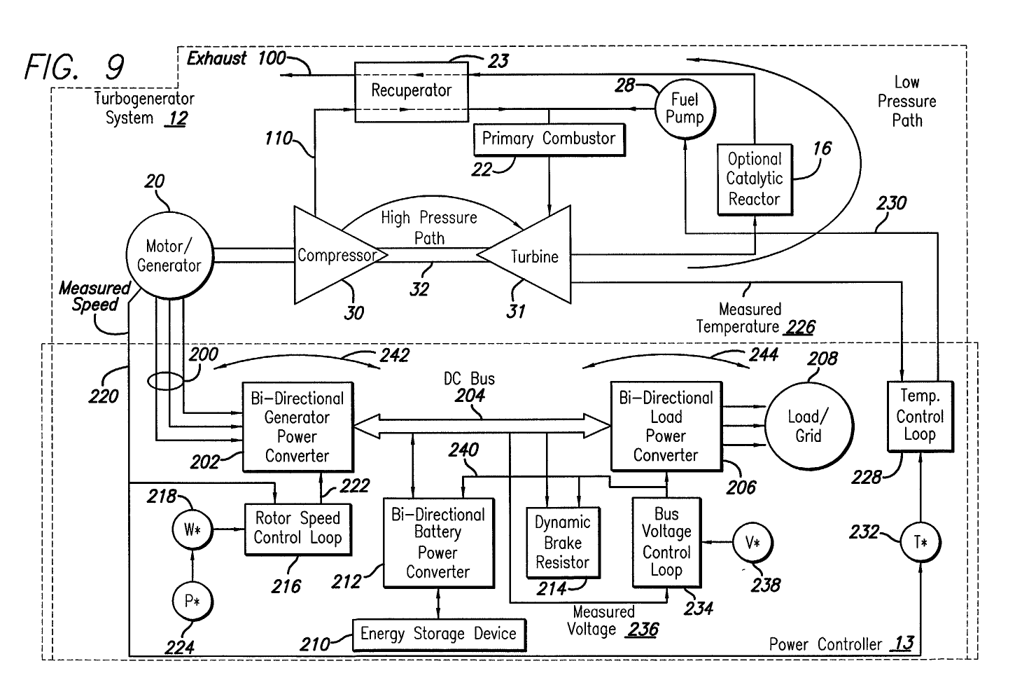

Referring to FIG. 9, integrated turbogenerator system 12 incorporates power controller 13, which applies AC output 200 from motor/generator 20 to bi-directional generator power converter 202. Power converter 202 is connected to DC bus 204 and includes a series of computer operable switches, such as IGBTS, that are selectively operated as an AC to DC converter to apply a selected amount power from AC output 200 to DC bus 204, or as a DC to AC converter to apply a selected amount of power from DC bus 204 to generator power converter 202. Generator power converter 202 is therefore selectively operable to transfer power or current in and out of motor/generator 20, thereby changing the torque applied therefrom to common shaft 32. A more detailed description of an appropriate power controller is disclosed in U.S. pat. app. Ser. No. 09/207,817 filed on Dec. 8, 1998 in the names of Gilbreth, Wacknov and Wall and assigned to the assignee of the present application, and which is incorporated herein in its entirety by reference thereto.

Bi-directional load power converter 206, operating as a DC to AC converter, applies DC power to DC bus-204 to provide to load/grid 208. If load/grid 208 includes a source of energy, load power converter 206 may operate as an AC to DC or a DC to DC converter to apply power from load/grid 208 to DC bus 204. In particular, load/grid 208 may be an AC utility grid from which power may also be applied to DC bus 204 via load power converter 206 when integrated turbogenerator system 12 is operated to support a utility grid. Load/grid 208 may be an AC or DC load when integrated turbogenerator system 12 is operated in a stand alone mode. Similarly, load/grid 208 may be a combination of an AC or DC load and a utility grid when integrated turbogenerator system 12 is operated in an UPS or uninterruptable power supply mode.

Power may also be applied to DC bus 204 from energy storage device 210 via bi-directional battery power converter 212 operating as a DC to DC converter. For example, battery power converter 212 may apply power from DC bus 204 to energy storage device 210 for off-loading power from DC bus 204 and/or for recharging energy storage device 210. Additionally, power may also be off-loaded from DC bus 204 via dynamic brake resistor 214 connected thereto.

In a typical method of operation of integrated turbogenerator system 12, battery 210 or grid 208 provide power during startup through power converter 212 or 206, respectively, to supply heater 96. When turbogenerator 12 reaches operating speed, power is drawn from generator 20 through power converter 202 to supply heater 96. The speed of common shaft 32 (and therefore the rotor speed of motor/generator 20 as well as the rotational or engine speed of both compressor 30 and turbine 31) is controlled by rotor speed control loop 216. Speed control loop 216 receives a speed command or speed setpoint from speed command W* 218 as well as speed measurement 220 from motor/generator 20, compressor 30, turbine 31, or common shaft 32. Speed control loop 216 may preferably operate as a closed loop feedback control which applies the difference between speed command W* 218 and speed measurement 220 as speed error signal 222 as a control signal to generator power converter 202.

If speed error signal 222 indicates that rotor speed should be reduced, generator power converter 202 increases the amount of power applied from motor/generator 20 via AC output 200 to DC bus 204 increasing the load on motor/generator 20 which increases the torque load on common shaft 32, which reduces the speed of common shaft 32 and therefor reduces rotor speed. If speed error signal 222 indicates that rotor speed should be increased, generator power converter 202 decreases the amount of power applied from motor/generator 20 via AC output 200 to DC bus 204 decreasing the load on motor/generator 20 which decreases the torque load on common shaft 32. This increases rotor speed because the rotational forces applied by the exhaust gases from primary combustor 22 to turbine 31 have not changed so that a decrease in torque load on common shaft 32 results in an increase in speed for common shaft 32.

Similarly, if speed error signal 222 indicates that rotor speed should be reduced, the amount of power applied from motor/generator 20 via AC output 200 to DC bus 204 can be increased, to increase the torque load on motor/generator 20 by increasing the load on DC bus 204 through appropriate modulation of brake resistor 214, by operation of battery power converter 212 to apply power from DC bus 204 to energy storage device 210, and/or by increasing the power applied by load power converter 206 to load/grid 208. If speed error signal 222 indicates that rotor speed should be increased, power from DC bus 204 may be applied to motor/generator 20 to operate motor/generator 20 as a motor. For example, at start up, shut down or during other transient conditions when the rotational power applied to common shaft 32 from the exhaust gases of primary combustor 22 is not sufficient to achieve or maintain the desired speed specified by speed command 218, it may be advantageous to continue the rotation of common shaft 32 at the specified speed by applying power from DC bus 204 via generator power converter 202 to motor motor/generator 20.

In a preferred embodiment, speed command 218 receives as its input power command 224 which may be provided from a user-selected power command and/or a measurement or other indication of the power being applied or to be applied by load power converter 206 to load/grid 208. In this manner, the rotor speed of integrated turbogenerator system 12 is maintained in a closed loop feedback control in accordance with the power being, or to be provided, to the load. During operation of integrated turbogenerator system 12, the operating temperature 226 of turbine 31, often measured as the turbine exhaust temperature or TET, is applied as an input to temperature feedback control loop 228 where it is compared with a temperature setpoint, such as commanded temperature T* 232, to generate temperature error or control signal 230 which is then applied to fuel pump 28. In this manner, the operating temperature of integrated turbogenerator system 12 may be regulated or controlled to a predetermined temperature by adjusting the fuel supplied to primary combustor 22, thus substantially if not completely decoupling operating temperature from turbine speed. The operating temperature may therefore be selected and maintained to optimize the operations of primary combustor 22 and/or low pressure catalytic reactor 16 without undesirable impact on actual rotor speed.

Integrated turbogenerator system 12 advantageously decouples speed and temperature control by controlling speed to a value selected in accordance with the power to be provided and by separately controlling temperature to a value selected for optimized performance (such as, for example, optimized for complete combustion of fuel and reduction of hydrocarbons in the exhaust gas). This control technique permits the operation of integrated turbogenerator system 12 at an optimized temperature and an optimized speed at many operating conditions in addition to full load, such as at start up, shut down, and during other transient conditions.

It has also been determined that the preselected operating temperatures may be advantageously different for different operating speeds. For example, it may be advantageous to select and maintain an operating temperature or temperatures for start up, shut down and transient response that are different, typically lower, than the operating temperature selected and maintain under full load conditions. Speed measurement 220 may conveniently be applied to as an input to commanded temperature T* 232 so that the regulated operating temperature may be selected in accordance with rotor speed or rotor speed ranges. It is important to note that the use of speed measurement 220 in selecting the commanded temperature T* 232 does not have the same result as adjusting the fuel flow to control speed. In integrated turbogenerator system integrated turbogenerator system 12, the temperature is maintain at values chosen by design for various operating conditions while speed is controlled to a value selected in accordance with power.

Under certain operating conditions, the decoupled speed and temperature control loops of integrated turbogenerator system 12 may well result in a situation in which the fuel flow provided by fuel pump 28 to primary combustor 22 results in the production of a higher amount of exhaust 100 being applied to turbine 31 than is required for the desired rotor speed. In this situation, excess drag or torque may then be applied by rotor speed control loop 216 to common shaft 32 beyond what is required by motor/generator 20 to produce the amount of AC output 200 required at that time by DC bus 204. Although some minor levels of efficiency may be lost under such conditions, these are transient conditions lasting a relatively short amount of time so that the overall efficiency of integrated turbogenerator system 12 remains extremely high while providing reliable operation over a relatively wide range of operating speeds.

Under the above described conditions, as well other transient conditions, it is important to maintain the voltage of DC bus 204 at a controlled and constant value. The control of the DC bus voltage 236 is provided by a further control loop, DC bus voltage control loop 234, which is substantially decoupled from the above described speed and temperature control loops. During operation of integrated turbogenerator system 12, DC bus voltage control loop 234 receives measured bus voltage 236 as an input. Measured bus voltage 236 is compared to preselected or commanded DC bus voltage V* 238 in DC bus voltage control loop 234 to generate voltage error or voltage control signal 240, which may be applied to battery power converter 212, brake resistor 214, and/or load power converter 206. If measured bus voltage 236 begins to drop, the amount of power being removed from DC bus 204 for application to load/grid 208 may be reduced by operation of load power converter 206, and/or power may be applied from load/grid 208 if an energy source is included therein, to prevent such bus voltage drop. Further, power may be applied to DC bus 204 from energy storage device 210 under the direction of battery power converter 212 to prevent bus voltage drop. If measured bus voltage 236 begins to exceed commanded DC bus voltage V* 238, power may be removed from DC bus 204 to limit the voltage increase by applying more power to DC bus 204 from load/grid 208 under the control of load power converter 206, or by applying power to energy storage device 210 under the control of battery power converter 212, and/or by dissipating excess power in brake resistor 214 which may be modulated on and off under the control of DC bus voltage control loop 234.

In summary, power controller 13 of integrated turbogenerator system 12 includes three decoupled or independent control loops in which temperature is regulated to a setpoint by varying fuel flow, power or current is added to or removed from motor/generator 20 under control of generator power converter 202 to control rotor speed to a setpoint, as indicated by bi-directional arrow 242, and bus voltage is controlled to a setpoint as generally indicated by bi-directional arrow 244 by applying or removing power from DC bus 204 under the control of load power converter 206 and from energy storage device 210 under the control of battery power converter 212. Power may also be removed from DC bus 204 by modulating the application of dynamic brake resistor 214 across DC bus 204.

A further advantage of the use of the integrated turbogenerator system topology shown in FIG. 9, when using a catalytic reactor as primary combustor 22, especially during transient conditions such as start up, is that any excess unburned hydrocarbons in the exhaust of the primary combustor 22 due to the excess of fuel resulting from the decoupling of the fuel or temperature control loops from speed and voltage control, are automatically eliminated by low pressure low pressure catalytic reactor 16.

While the embodiment generally shown in FIG. 9 employs fuel pump 28, the flow and pressure of the liquid fuel to can also be controlled by a liquid fuel pressurization and control system such as described in U.S. Pat. No. 5,873,235 issued Feb. 23, 1999 to Robert W. Bosley et al., entitled “Liquid Fuel Pressurization and Control Method,” assigned to the same assignee as this application and incorporated herein in its entirety by reference thereto.

Having now described the invention in accordance with the requirements of the patent statutes, those skilled in the art will understand how to make changes and modifications to the present invention to meet their specific requirements or conditions. Such changes and modifications may be made without departing from the scope and spirit of the invention, as defined and limited solely by the following claims.

What is claimed is:

1. A turbine engine, comprising:
a turbine driven by hot gas;
a combustor for combusting fuel and compressed air to generate the hot gas;
a fuel injector connected to the combustor to introduce liquid fuel into the combustor; and
a source of heat external to the combustor and coupled to the injector for heating the injector to vaporize the liquid fuel flowing therethrough.

2. The turbine engine of claim 1, wherein the source of heat comprises:
exhaust gas from the turbine.

3. The turbine engine of claim 2, wherein the fuel injector comprises:
a fuel tube for ducting the fuel into the combustor; and
an air tube disposed around the fuel tube and formed with openings in its wall for allowing the exhaust gas to pass through to heat the fuel tube.

4. The turbine engine of claim 3, comprising:
a compressor rotationally coupled to the turbine to provide the compressed air to the combustor;
an annular recuperator disposed around the turbine, the combustor, and the compressor for receiving the turbine exhaust from the turbine and the compressed air from the compressor to transfer heat therebetween; and
a hot passage connected between the turbine and the recuperator for conducting the turbine exhaust, the fuel injector extending through the hot passage.

5. The turbine engine of claim 4, wherein the source of heat further comprises:
electric power.

6. The turbine engine of claim 5, wherein the source of heat comprises:
an electric heater.

7. The turbine engine of claim 6, comprising:
a power controller connected to the engine and to a source of electric power to provide electric power to the electric heater.

8. The turbine engine of claim 7, wherein the source of electric power includes any one or more of a battery, an electric generator, and an electric utility grid.

9. The turbine engine of claim 1, wherein the source of heat comprises:
electric power.

10. The turbine engine of claim 9, wherein the source of heat comprises:
an electric heater.

11. The turbine engine of claim 10, wherein the electric heater comprises:
an electric band heater disposed around the injector.

12. The turbine engine of claim 10, comprising:
an electric generator rotationally coupled to the turbine to generate the electric power.

13. The turbine engine of claim 12, comprising:
a power controller connected to the engine and to a source of electric power to provide electric power to the electric heater.

14. The turbine engine of claim 13, wherein the source of electric power includes any one or more of a battery, the electric generator, and an electric utility grid.

15. A method of operating a turbine engine having a combustor for combusting liquid fuel and compressed air to generate hot gas, comprising:
passing liquid fuel through an injector and into the combustor to be combusted therein;
connecting a source of heat to the injector, the source of heat external to the combustor; and
heating the injector to a temperature sufficient to vaporize the liquid fuel flowing therethrough.

16. The method of claim 15, wherein heating the injector comprises:
heating the injector with exhaust gas from the turbine.

17. The method of claim 16, wherein the fuel injector comprises:
a fuel tube for ducting the fuel into the combustor; and
an air tube disposed around the fuel tube and formed with openings in its wall for allowing the exhaust gas to pass through to heat the fuel tube.

18. The method of claim 17, wherein the turbine engine comprises:
a compressor rotationally coupled to the turbine to provide the compressed air to the combustor;
an annular recuperator disposed around the turbine, the combustor, and the compressor for receiving the turbine exhaust from the turbine and the compressed air from the compressor to transfer heat therebetween; and
a hot passage connected between the turbine and the recuperator for conducting the turbine exhaust, the fuel injector extending through the hot passage.

19. The method of claim 18, wherein heating the injector comprises:
heating the injector with electric power during startup of the turbine engine.

20. The method of claim 19, wherein heating the injector comprises:
heating the injector with an electric heater.

21. The method of claim 20, wherein the turbine engine comprises:
a power controller connected to the engine and to a source of electric power to provide electric power to the electric heater.

22. The method of claim 21, wherein the source of electric power includes any one or more of a battery, an electric generator, and an electric utility grid.

23. The method of claim 15, wherein heating the injector comprises:
heating the injector with electric power.

24. The method of claim 23, wherein heating the injector comprises:
heating the injector with an electric heater.

25. The method of claim 24, wherein heating the injector comprises:
heating the injector with an electric band heater disposed around the injector.

26. The method of claim 24, wherein the turbine engine comprises:
an electric generator rotationally coupled to the turbine to generate the electric power.

27. The method of claim 26, wherein the turbine engine comprises:
a power controller connected to the engine and to a source of electric power to provide electric power to the electric heater.

28. The method of claim 27, wherein the source of electric power includes any one or more of a battery, an electric generator, and an electric utility grid.
